(19) United States
(12) Patent Application Publication
(10) Pub. No.: US 2015/0174813 A1
(43) Pub. Date: Jun. 25, 2015

(54) APPARATUS FOR THE SHAPING OF PLASTICS MATERIAL PRE-FORMS INTO PLASTICS MATERIAL CONTAINERS WITH SAFETY FUNCTION FOR THE RETURN OF BLOW MOULDING NOZZLES

(71) Applicant: KRONES AG, Neutraubling (DE)

(72) Inventors: Eduard HANDSCHUH, Donaustauf (DE); Florian GELTINGER, Donaustauf (DE)

(73) Assignee: KRONES AG, Neutraubling (DE)

(21) Appl. No.: 14/571,998

(22) Filed: Dec. 16, 2014

(30) Foreign Application Priority Data
Dec. 23, 2013 (DE) 10 2013 114 801.8

(51) Int. Cl. B29C 49/60; B29C 49/12

(52) U.S. Cl. CPC B29C 49/60; B29C 49/12; B29C 2049/129; B29C 2049/5875

(57) ABSTRACT

An apparatus (1) for the shaping of plastics material pre-forms (10) into plastics material containers (20), with a movable carrier (2) on which are arranged a plurality of shaping stations (40), wherein these shaping stations (40) form in each case cavities in which the plastics material pre-forms (10) are capable of being expanded into the plastics material containers with a flowable medium, and wherein the shaping stations (40) have in each case stressing devices (42) which act upon the plastics material pre-forms (10) with the flowable medium, as well as stretch rods (8) which are capable of being introduced into an internal space of the plastics material pre-forms (10) in order to stretch the aforesaid plastics material pre-forms (10) in the longitudinal direction (L) thereof, and wherein the apparatus has at least one drive arrangement (30) in order to move the stressing devices (42) relative to the plastics material pre-form (10). According to the invention the drive arrangement (30) has at least one first valve device (34), wherein a change in a switching state of this valve device (34) triggers the removal movement of the stressing device (42) and the shaping station (40) has a safety means (36, 54, 56, 46) which even in the event of failure of an element of the first drive arrangement (30) effects or releases the removal of the stressing devices (42) from the plastics material pre-form in a manner dependent upon a pressure prevailing in the container at a pre-determined moment in time, in that a change in the switching state of the valve device (34) is constrained and/or avoided.

The present invention relates to an apparatus and a method for the shaping of plastics material pre-forms into plastics material containers. Apparatus and methods of this type have long been known from the prior art. In this case it is customary for heated plastics material pre-forms to be acted upon with a flowable medium, and in particular with blow moulding air, in order to be shaped into plastics material containers in this way. For this purpose the plastics material pre-forms are introduced into blow moulds.

After that, a blow moulding nozzle is applied to the plastics material pre-form or to a component of the blow mould and, after that, the plastics material pre-form is acted upon with the blow moulding air by way of this blow moulding nozzle, in order to be expanded in this way. After the plastics material containers have been completed this blow moulding nozzle is removed from the plastics material pre-form again. This procedure is very important in this case. If a return of the blow moulding nozzle does not in fact take place, the latter can collide with other elements of the shaping apparatus, for example gripping clamps, in the further procedure and severe damage to the machine can occur. After the completion of the blow moulding or the shaping respectively of the plastics material container inside the mould carrier the blow moulding nozzle has therefore to be removed again or raised again respectively.

This is achieved in part in the prior art by way of a coupling with a stretch rod. This stretch rod is used in working operation for stretching the plastics material pre-form in the longitudinal direction thereof. In order also to ensure, however, that the blow moulding nozzle—or also referred to below as a stressing device respectively—has in fact been returned again or entrained upwards respectively, a blow moulding slide is provided which follows a curve, as a result of which (if the blow moulding nozzle has not already been raised by the movement of the stretch rod) this blow moulding nozzle is then raised at the latest. In this way, a forced release is carried out. This is necessary on grounds of safety, since the blow moulding nozzle could result in serious damage if it is not raised upwards. This cam-controlled return movement of the blow moulding nozzle is relatively complicated, however, and requires a further stationary cam.

A valve device for a glass device operating at high pressure is known from DE 10 2009 059 829 A1. DE 10 2010 003 623 A1 describes a mould carrier unit for the shaping of containers by a stretching procedure with a controlled nozzle as well as a stretching mandrel. A blow moulding tool and a blow moulding method for the blow moulding and sealing of sterile bottles, which are opened and filled after the shaping without the need for sterilization before the filling, are known from DE 602 02 713 T2.

The object of the present invention is therefore to ensure the safety of the machine, and at the same time, however, to dispense with stationary guide cams. These objects are attained according to the invention by the subjects of the independent claims. Advantageous embodiments and further developments form the subject matter of the sub-claims.

An apparatus according to the invention for the shaping of plastics material pre-forms into plastics material containers has a movable carrier on which are arranged a plurality of shaping stations, these shaping stations in each case forming cavities in which the plastics material pre-forms are capable of being expanded or shaped respectively into the plastics material containers with a flowable medium. In addition, the shaping stations have in each case stressing devices which act upon the plastics material pre-forms with the flowable medium, as well as stretch rods which are capable of being introduced into an interior of the plastics material pre-forms in order to stretch the aforesaid plastics material pre-forms in the longitudinal direction thereof. In this case the apparatus has at least one drive arrangement in order to move the stressing devices relative to the plastics material pre-forms, this drive arrangement preferably having a first drive device in order to remove the stressing device—in particular after an expansion of the containers—from the plastics material pre-form.

It is advantageous for the apparatus to have at least one drive device and it is preferable for the shaping stations to have one drive arrangement in each case in order to move the stressing devices with respect to the plastics material pre-forms. This drive device, which removes the stressing device from the plastics material containers, is preferably a drive device which performs a further movement task or which moves a further element of the shaping station respectively. In particular, the drive device which removes the stressing device from the containers is a drive device which moves a stretch rod out of the containers.

It is advantageous for the stressing device itself to be moved, in particular in a longitudinal direction of the containers, and the containers are not moved in the longitudinal direction thereof in this stage of the procedure. It would also be possible, however, for the plastics material pre-forms to be moved in the longitudinal direction thereof in order to be removed from the stressing device in this way.

According to the invention the drive arrangement has at least one first valve device, in which case a change in a switching state of this valve device releases (or triggers respectively) a removal movement of the stressing device and the apparatus or at least one shaping station respectively has a safety means which even in the event of failure of an element of the drive arrangement effects the removal of the stressing device from the plastics material pre-form, in particular in a manner dependent upon a pressure prevailing in the container at a pre-determined point in time.

It is preferable for the safety means to effect the removal of the stressing device in that a change in the switching state of the valve device is forced and/or avoided. In addition or as an alternative, it would also be possible for the apparatus to have a safety means which even in the event of failure of an element of the drive arrangement effects the removal of the stressing device from the plastics material pre-form in a manner dependent upon a position of the shaping station along the conveying path of the plastics material pre-forms.

With this design the position at which a shaping station is present is checked, in particular a position in the peripheral direction of a blow moulding wheel. If this is a position in which a withdrawal of the stressing device would have to be initiated, the safety means can be activated accordingly.

A change in the switching state of the valve device is generally understood as meaning that this valve initiates, carries out or at least effects a movement of the stressing device as a result of some sort of physical change of a state of this valve. In this way for example, the stressing device can be fed to the plastics material pre-form by means of a gas pressure and when released this gas pressure or the fact that this gas pressure is no longer present respectively can have the effect that a return movement or removal respectively of the stressing device from the plastics material pre-form takes place. This means that with a normal operation of the apparatus the aforesaid valve or the valve device respectively is responsible or is jointly responsible respectively for the return movement of the stressing device.

Safety means are therefore proposed which react, in particular, in reaction to an internal pressure in the container. The emergency cams used in part in the prior art act on the other hand upon their conveying path in a manner dependent upon the individual blow moulding station, in particular a position of the blow moulding station in the direction of rotation of the blow moulding wheel.

It is preferable for the stressing device, such as for example a blow moulding nozzle, to be coupled to the stretch rod, for example by way of a cone on the stretch rod. During the stretching, in particular during electrical stretching, the stretch rod moves downwards together with the blow moulding nozzle, i.e. towards the plastics material pre-form. In this case a pressure present in a static state acts upon a blow moulding piston of the stressing device. The pressure upon the blow moulding piston is increased in this case in proportion to the pressure which is present in the container. This means that the force which acts downwards from the blow moulding piston and the force which acts upwards as viewed from the container are of substantially equal magnitude in this situation.

It is preferable, however, for the stressing device to be pressed with an additional force against the containers. In order that the stressing device can be properly sealed off in this case, however, it is preferable for an additional pressure to be exerted from above upon the blow moulding nozzle, i.e. the pre-stressing force. In this case a pre-stressing means acting in a pneumatic manner can be provided for reaching this pre-stressing force. It would likewise be possible, however, for this additional pre-stressing force to be produced in a magnetic manner or to be provided by a spring.

In the situation in which the blow moulding nozzle or the stressing device respectively is sealed off, for example on a carrying ring of the container, and the container is blow moulded completely, a very high pressure prevails in the bottle and also in the annular space below the blow moulding piston. This pressure cannot escape in this case. As a result, a very high force of in particular several kN acts downwards upon the blow moulding nozzle or the stressing device respectively.

In the normal case the EXH valve (exhaust valve) would now open. As a result, the pressure in the annular space and the bottle drops and the stretching drive with a maximum force of 2 kN can raise the stretch rod. Since the blow moulding nozzle is coupled by way of the cone of the stretch rod, the latter also moves jointly upwards. It is not possible for a collision with other components to occur.

In the event that the EXH valve cannot open, the problem arises that the force which occurs on account of the prevailing pressure in the annular space and the bottle is higher than the maximum force of the drive of the stretch rod. The stretch rod cannot therefore rise, as a result of which the blow moulding nozzle also remains in the lower position thereof, and this can also lead to collisions.

In order that this should not occur, but there should be no need at the same time to provide an additional cam which, as hitherto, ensures after a defined process angle that a forcible release is initiated, within the scope of the invention a plurality of safety means are specified which still permit a venting of the annular space. What all these safety means have in common, however, is the fact that they cause a return of the stressing device even without a mechanical guide cam.

It is preferable for the valve device to be switched in such a way that in one switching state it causes a pressure stressing, this pressure stressing in turn causing a feed of the stressing device towards the plastics material pre-form. If this pressure stressing is absent, the stressing device is preferably raised off the plastics material pre-form or returned respectively. In this way, it is possible for the stressing device not to be fed to the plastics material pre-form in a state without pressure. It is advantageous for the valve device to be a pilot valve which for example controls a pressure stressing for a pneumatic device for the return of the stressing device or a venting of a device of this type.

It is preferable for the drive device likewise to be a pneumatic drive device, and in particular a drive device in which a piston element and action of a gaseous medium are moved.

The invention now proposes that in the event of any failure of the aforesaid valve no return of the stressing device by way of a guide cam should take place, but the switching state of the valve device, or the change thereof respectively, is constrained by other means or this change is avoided, as explained below, for example by the provision of a second redundant valve. In this case, however, this change in particular is (also) effected or avoided in a manner dependent upon an internal pressure in the container.

It is advantageous for the movable carrier to be a rotatable carrier and, in particular, a blow moulding wheel on which are arranged a plurality of shaping devices. It is preferable for each shaping station to have associated with it one safety means of this type. It would also be possible, however, for a plurality of safety means to be provided. It would be additionally possible for a safety means to be associated with a plurality of or all of the shaping stations.

It is advantageous for the apparatus also to have a plurality of valves which control the feed of the flowable medium to the plastics material pre-form. In this way, the shaping of the plastics material pre-forms can be carried out by acting upon them at a multiplicity of different pressure levels, for example by acting upon them at a preliminary blow moulding pressure, and/or an intermediate blow moulding pressure and a final blow moulding pressure.

The flowable medium for acting upon the plastics material pre-forms to form plastics material containers is, in particular, air. In this case, however, it is also possible for sterile air to be used.

The valve device is, in particular, a pneumatic valve which controls air flows. A change in the switching state of this valve can be carried out in this case for example by a likewise pneumatic pilot valve, but other procedures would also be possible, such as for example a magnetic circuit or an electrical circuit of the valve. In addition, the valve could be switched by mechanical steps.

The drive device for the return of the stressing device can be, in particular, a pneumatic drive device in this case. In this way, the valve device can be, for example, a pilot valve which can effect a venting or aeration of a valve chamber of the pneumatic drive device, in which case the return of the stressing device is caused by this aeration or venting.

It is therefore preferable, in the event of failure of the valve device, for a change in the switching to be carried out within the framework of an emergency operation. In this way, on the one hand a safe return of the stressing device or a forcible release respectively is provided, but on the other hand the blow moulding slide mentioned above or a blow moulding nozzle cam respectively are omitted.

In addition or as an alternative, it would also be possible, if a failure of the valve device is detected, for other steps to be taken, for example for an emergency stop to be initiated or for further elements which could collide with the stressing device to be removed or moved away respectively from a collision area. The Applicants reserve the right also to claim protection for designs of this type. In this case the apparatus has a detection device which detects a failure (in particular in the future) of a valve device and preferably emits a signal which causes a specific reaction of the apparatus, such as for example the emergency stop described above.

It is preferable for the stressing device to be a blow moulding nozzle. It is preferable for the drive arrangement also to have a drive device which feeds the stressing device to the plastics material pre-forms, for example lowers them onto the plastics material pre-forms or the blow moulds respectively in which the plastics material pre-forms are arranged. In this case this feed movement can also be carried out in a pneumatic manner.

In this case it is possible for the same drive device both to supply the stressing device to the plastics material pre-forms and to remove the stressing device from the plastics material pre-forms.

It would also be possible, however, for the movement of the stressing device to be coupled at least for a time to a movement of the stretch rod, for example for the stressing device to be coupled or jointly entrained respectively with the movement of the stretch rod at least for a time. In this way, it would also be possible for this coupling to be designed in such a way that it acts only in the event of failure of the valve device and, in this way, for a change in the switching state of the valve to be avoided.

In this case, in addition to the pneumatic movement described here, it would also be possible for other drive devices to be provided which cause the stressing device to be fed to the plastics material pre-form, such as for example electric motor drives or linear motors.

In the case of a further advantageous embodiment the movement which removes the stressing device from the plastics material pre-form is carried out without the use of stationary guide elements or takes place without the use of stationary guide elements respectively. In this case, in particular, a stationary guide cam is not provided which permits a return movement of the stressing device. It is advantageous, in order to achieve a removal movement of the stressing device from the plastics material pre-form, for no guide elements movable with respect to one another, such as for example a stationary guide cam and guide rollers movable opposite the latter, to be provided and preferably no mechanical elements to be provided.

In this way, the stressing device or the blow moulding nozzle respectively or the blow moulding piston or even adjacent components is or are not moved by stationary cams, and in particular also not locally, but for example by way of the aforesaid valve and/or by a coupling at least in part with for example the drive of a stretch rod or the transfer elements thereof respectively, such as for example a stretching slide, the stretch rod itself or the like.

It is also preferable for a mechanical, transfer between an element arranged so as to be stationary and, in particular, installed in a fixed manner, such as for example an emergency cam, and the stressing device or the blow moulding nozzle respectively or the blow moulding piston not to be carried out in any operating state of the apparatus, not even in the event of a failure occurring, in particular of the valve device specified above. In this way, the return movement of the stressing device is preferably carried out in a manner exclusively without guide cams.

It is preferable for no mechanical elements, such as for example guide rollers, blow moulding slides or catching devices, which permit an interaction with a component which, in particular, is stationary and, in particular, is arranged outside the rotating carrier, to be provided on the blow moulding nozzle or the blow moulding piston respectively.

In other words, the movement which removes the stressing device from plastics material pre-forms is carried out or initiated respectively without the use of stationary guide elements.

In the case of a preferred embodiment, in addition to the first valve device, a second valve device is provided which is likewise suitable—as a result of a change in a switching state of this second valve device—for triggering and/or releasing the removal movement of the stressing device. In this case it is possible for these two valve devices to be present in a redundant manner, in which case in particular the change in the switching state of only one valve is sufficient to initiate the return movement of the stressing device. It would also be possible, however, for a control means to cause the second valve to switch only when a defect or an error of the first valve device is observed. It is advantageous for this first valve device and the second valve device to be controlled independently of each other and/or to have control devices independent of each other.

In the case of a further advantageous embodiment the first valve device has two control devices independent of each other at least in part in order to control this valve device. In this case the safety of the system or the safety device respectively is implemented in such a way that one valve device has two or at least two control devices arranged in parallel and in a redundant manner, and in particular two electrical or electro-pneumatic pilot control devices arranged in parallel and in a redundant manner.

In the case of a further advantageous embodiment the apparatus has a detection device which detects an error function of the first valve device. In this way, it is possible for example for a non-switching—in particular a future non-switching—of this valve to be detected or even the fact that the valve has not switched at the point in time provided for it. In addition, the apparatus also has in this case an output device which in reaction to a detected error preferably emits a signal, and in particular a signal which causes a movement of the stressing device away from the plastics material pre-form. It is also possible, however, for other signals to be emitted, as mentioned above, for example signals which trigger an emergency stop of the apparatus.

In the case of a further advantageous embodiment the apparatus has a venting device which in the event of a failure of the valve device causes a venting of at least one fluid space used for changing the switching state of this valve device. If a defective valve is not switched, it is possible, in particular, for a space of this valve not to be vented, so that the valve cannot return to a basic setting. In this case it is proposed that a venting of a valve space or even a venting of an annular space which supplies this valve should be carried out.

This venting in turn has the effect that the valve is forcibly switched and, in this way, the stressing device is removed from the plastics material pre-form. As mentioned, it would also be possible for an annular space which supplies this valve to be vented. In this case it is also optionally possible to accept that all the other valves of the other shaping stations are likewise switched. This would possibly result in the containers just finished not being completely finished, but this would possibly have to be accepted as against a collision or serious damage to the machine.

In addition, it would also be possible for this venting of a piston chamber of the valve device for example to be carried out by a stretching movement of a stretch rod.

In the case of a further preferred embodiment the apparatus has a pressure detection device which detects an internal pressure inside the container to be expanded. This pressure detection device can be connected in terms of control to the safety means in this case, so that the safety means can also be actuated in a manner dependent upon a supply line for the gaseous medium leading to the container. In this way, it is possible for the safety means to be activated only from a specified internal pressure in the container.

The present invention further relates to a method of shaping plastics material pre-forms into plastics material containers with the following steps:
transferring a plastics material pre-form to a shaping station,
bringing a stressing device up to the plastics material pre-form,
acting upon an internal space of the plastics material pre-form with a flowable medium for the expansion thereof,
moving the stressing device away from the plastics material pre-form or the container already blow moulded therefrom after the expansion of the plastics material pre-form has taken place respectively,
(optionally) removing the ready blow moulded container from the shaping station.

In this case a drive device is used in order to move the stressing device away from the plastics material pre-form, and this drive device has at least one first valve device, the removal movement of the stressing device being triggered or released respectively by a change in a switching state of this valve device.

According to the invention at least one safety means is provided and it is preferable for safety means to be provided which in the event of failure of the valve device cause and/or release a removal of the stressing device from the plastics material pre-form.

It is advantageous, in the event of a failure of the valve device, for the safety means to cause or avoid a change in the switching state of the valve device. It is advantageous for the safety means to cause or avoid a removal of the stressing device from the plastics material pre-form in a manner dependent upon a pressure prevailing in the container at a pre-determined point in time. In particular, this is a pressure, for example a finishing blow moulding pressure, prevailing in the container at the end of the blow moulding procedure. The pre-determined point in time is preferably a point in time at which the plastics material container is already completely expanded and/or a point in time at which the expansion of the container is concluded.

In this way, it is possible for example for it to be established that at a specified point in time in the blow moulding procedure, in particular at a point in time at which a release of the container must already have been carried out, an excessive pressure is still present in the container. In this case the safety means can effect a release of the container.

An avoidance of the change in the switching state is understood in this case as being that the return of the stressing device (for example of a blow moulding piston and/or a blow moulding nozzle) is also effected independently of this switching state.

It is preferable for two different switching states of the valve device to be distinguished, in particular with respect to the flows of the fluid volumes, and in particular gas volumes, present at this valve device and/or with respect to the fluid volumes, and in particular gas volumes, flowing through this valve device. In addition, the switching states preferably differ with respect to a setting of a piston element of this valve device (in particular a setting of this piston element with respect to a housing of the valve device).

In the case of an advantageous method the return of the stressing device is carried out by an electrical drive device. It is advantageous for the return to be carried out by coupling the movement of the stressing device to a movement of the stretch rod. It is preferable for a feed of the stressing device to be carried out pneumatically and preferably by way of a static pressure. As mentioned above, it is not necessary in this case for a drive device which exclusively carries out the return of the stressing device to be provided, it being preferable for a drive device which (also) moves another component, such as in particular the stretch rod, to be involved.

In the case of a further advantageous method, for the purpose of the shaping procedure a stretch rod is introduced into the plastics material pre-forms in order to stretch them and this stretch rod is moved out of the container again at a later period of time, in particular after the formation of the container has been carried out.

In the case of a further advantageous method the removal of the stressing device is carried out by a mechanical coupling of a movement of the stressing device to a movement of the stretch rod at least in the event of a failure of the valve device.

It is advantageous for the safety means to have a second valve device which at least also in the event of a failure of the first valve device carries out a removal of the stressing device from the plastics material pre-form.

Further advantages and embodiments are evident from the accompanying drawings. In the drawings

FIG. 1 is a diagrammatic illustration of an apparatus for the shaping of plastics material pre-forms into plastics material containers;

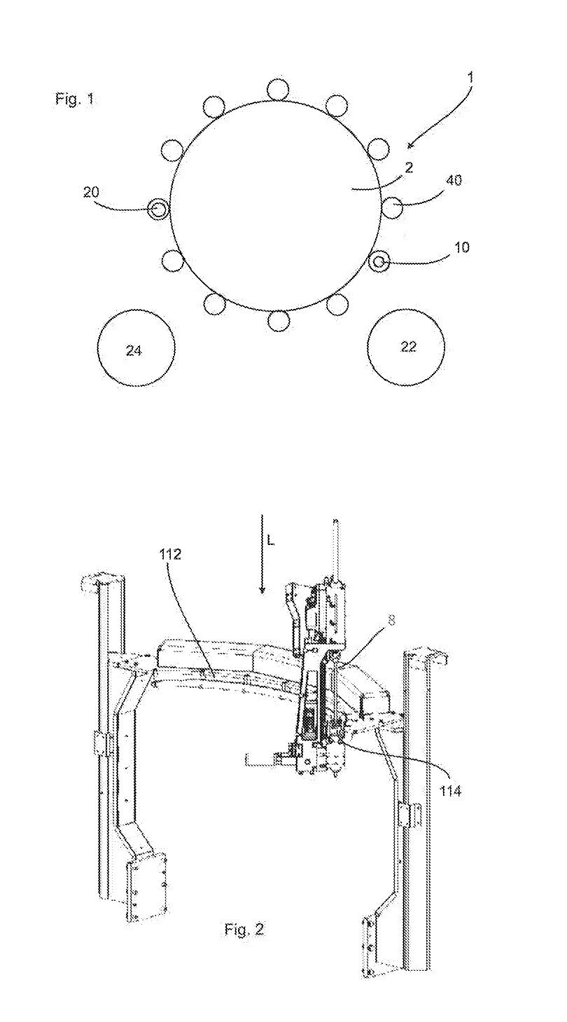

FIG. 2 is an illustration of an apparatus according to the prior art;

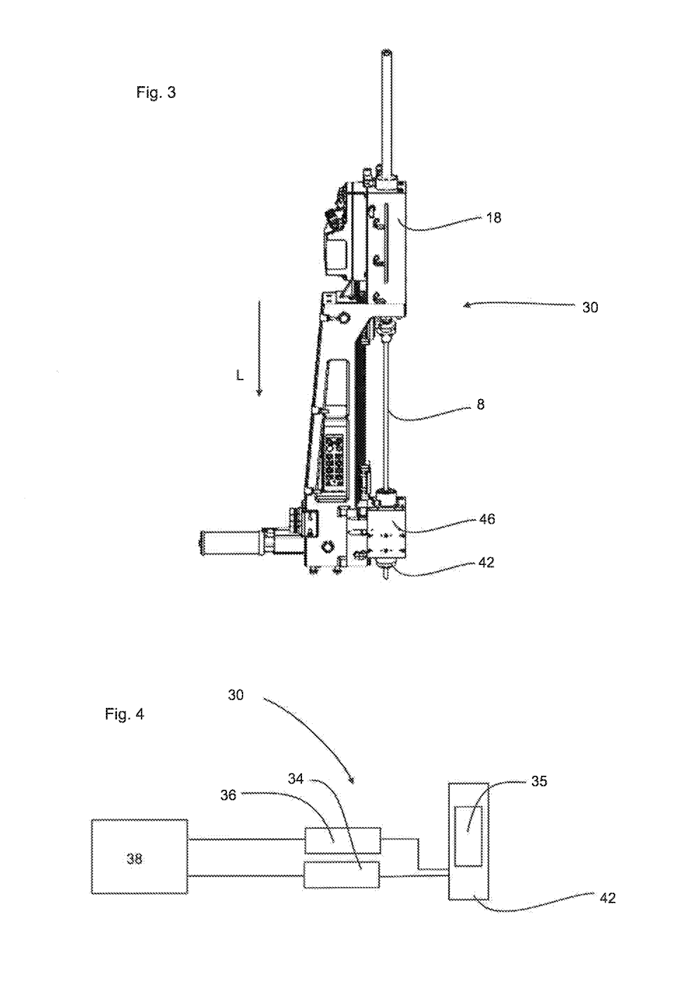

FIG. 3 is a partial illustration of a shaping station according to the invention;

FIG. 4 is a diagrammatic illustration of a first design according to the invention;

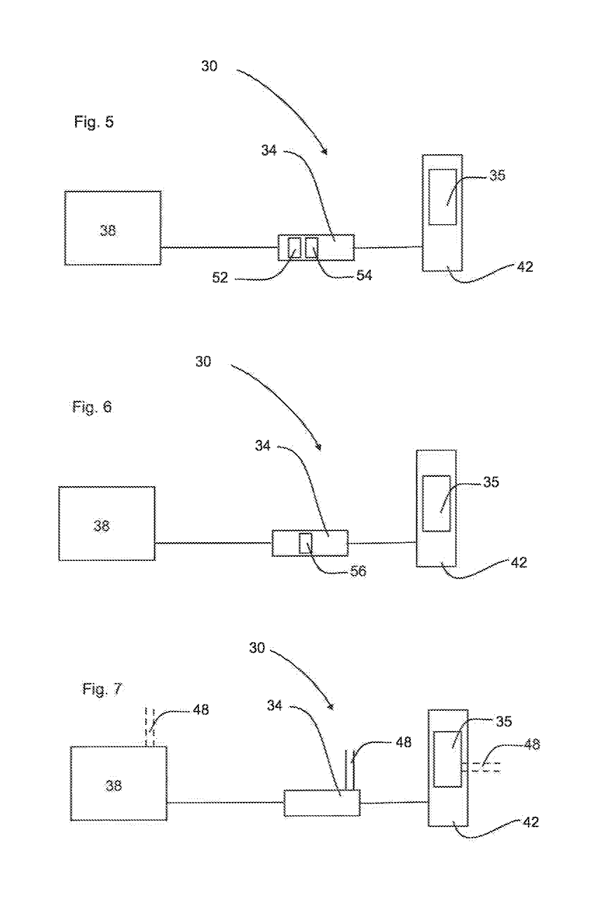

FIG. 5 is an illustration of a second design according to the invention;

FIG. 6 is an illustration of a third design according to the invention;

FIG. 7 is an illustration of a fourth design according to the invention;

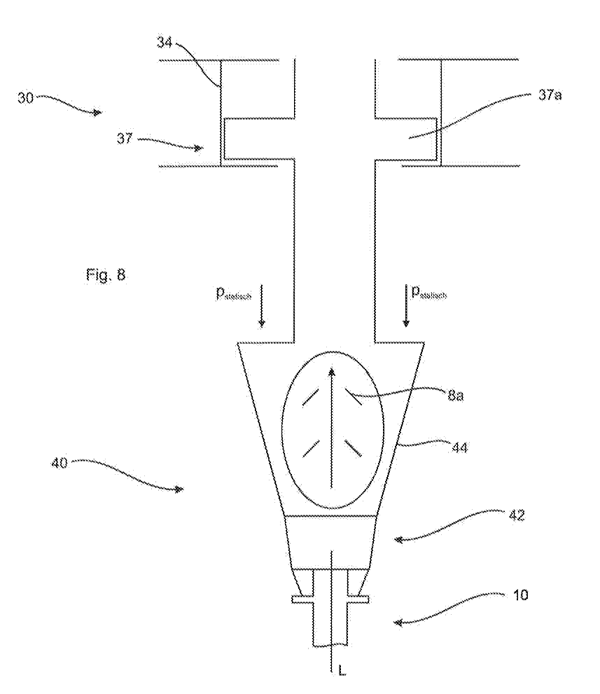

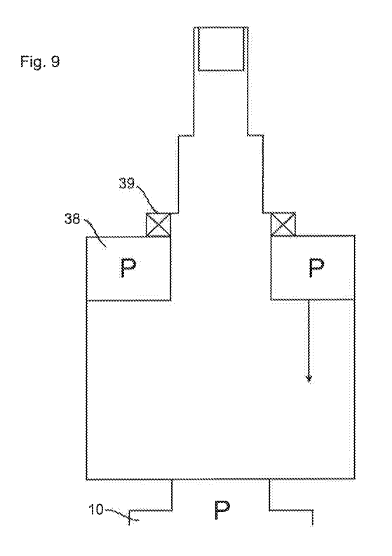

FIG. 8 is an illustration of a stressing device applied to a plastics material pre-form, and

FIG. 9 is an illustration to explain the pressure ratios.

FIG. 1 is a diagrammatic illustration of an apparatus according to the invention for the shaping of plastics material pre-forms 10 into plastics material containers 20. In this case the plastics material pre-forms are fed to the actual shaping device 1 by way of a feed device, such as for example a star wheel 22. A heating device (not shown), which heats the plastics material pre-forms before the shaping procedure, is usually arranged upstream of the shaping device 1. This shaping device 1 has in this case a carrier 2 which is rotatable about an axis orientated, in particular, vertically or towards the centre of the earth respectively and on which are arranged a plurality of shaping stations 40. These shaping stations have in this case lateral parts which are capable of being unfolded and which can receive a plastics material pre-form.

After their expansion to form the plastics material containers 20 the latter are removed again by way of a removal device 24 which can likewise be a star wheel.

FIG. 2 is a diagrammatic illustration of an apparatus according to the prior art. It will be noted that in this case a blow moulding nozzle cam 112 is provided which in the event of an emergency permits a return movement or a withdrawal respectively of the blow moulding nozzle arrangement. The reference number 114 designates a blow moulding slide which can roll with respect to this cam carrier or the blow moulding nozzle cam respectively. As mentioned above, the inventor has been confronted by the task of dispensing with this blow moulding nozzle cam whilst at the same time, however, ensuring in all events the return of the blow moulding nozzle.

FIG. 3 is a partial illustration of a shaping station according to the invention. In this case too, the stretch rod 8 will be noted, as well as a stretch rod drive 18 which is used to move the stretch rod in the longitudinal direction L. The stretch rod drive is preferably an electric motor drive or a pneumatic drive, but it would also be possible for use to be made of a drive by means of guide cams. The reference number 30 designates in a roughly diagrammatic manner a drive arrangement for moving the stressing device. In this case, as stated above, the return movement of the stressing device is coupled to the movement of the stretch rod, so that when the stretch rod is withdrawn the stressing device will also be withdrawn. The feed of the stressing device towards the containers is preferably carried out pneumatically. In addition, it is also preferable for the stressing device to be pressed against the containers by pneumatic means during the shaping procedure.

The reference number 42 designates a stressing device or a blow moulding nozzle respectively, which is applied to the plastics material pre-forms in order to act upon these plastics material pre-forms with air. For this purpose, this blow moulding nozzle 42 can also be moved downwards or upwards respectively in the longitudinal direction L. The reference number 46 designates a valve block which has a plurality of valves which control the feed of the blow moulding air into the plastics material pre-forms. In this case an exhaust valve is also provided which, in particular after the conclusion of the blow moulding procedure, releases the blow moulding air out of the now shaped plastics material pre-forms or plastics material containers respectively. A return movement of the blow moulding nozzle 42 can also be controlled or achieved respectively by way of this exhaust valve. Expressed in more precise terms, the exhaust valve is used in this case for the release of the annular space. As a result, the force upon the stressing device is reduced. The stressing device can therefore be raised off by the stretching drive. The exhaust valve therefore allows the stressing device to be raised. The return movement of the blow moulding nozzle itself is implemented by the coupling with the stretch rod.

In this way, it would be possible, as the plastics material pre-form is released, for the blow moulding nozzle 42 also to be withdrawn by a pneumatic drive device.

In one embodiment it would be possible for the movement of the blow moulding nozzle to be coupled locally to the movement of the stretch rod 8 and, in this way, to be withdrawn again with the movement of the stretch rod in each case.

FIG. 4 is a diagrammatic illustration of a first embodiment of the invention. In this case too, there will be noted the stressing device 42 and a drive arrangement 30 (for example in the form of an exhaust valve) which is illustrated only diagrammatically and which is designed in a pneumatic manner and effects a return movement of the stressing device 42. A first valve device 34 is provided for this purpose. Switching over this first valve device 34 causes a return of the stressing device in normal working operation. In this case it is possible for this valve device to act as a pilot valve for a valve or a valve space 35 of a valve respectively or in general a gas-receiving space 35 of a pneumatic drive device of the drive arrangement 30.

In addition to this first valve device 34, a second valve device 36 is provided which is connected parallel to the first valve device 34 and likewise effects a return of the stressing device. In this way, a second redundant pilot valve 36 is provided in this embodiment. If the first valve device 34 now breaks down, a release can be carried out and the return of the stressing device 42 can be carried out also by way of the second valve device 36. The reference number 38 designates a reservoir for compressed air.

During the expansion procedure it is possible for the stressing device to be fed to the plastics material pre-form by way of this reservoir and the switched-through valves 36 and 34. For the return a valve space of a valve device acting as a drive device can be vented. In the case of this embodiment the second valve device 36 is thus the safety device which effects or releases respectively or permits a removal of the stressing device from the plastics material pre-form even in the event of failure of an element of the first drive device, in that a change in the switching state of the valve device is constrained and/or avoided, in this case at least avoided.

In this case an internal pressure in the container can also be detected, and it can be provided that only from a specified internal pressure in the container is a switching of the second valve device possible, for example from an internal pressure which the drive device for driving the stretch rod can no longer overcome.

FIG. 5 illustrates a further embodiment of an apparatus according to the invention. In the case of this embodiment only the first valve device 34 is provided, but two pilot control devices, in particular electrical or electro-pneumatic pilot control devices, 52 and 54 present in a redundant manner are provided on this first valve device. If one of these control devices 52 now breaks down, the valve device 34 is nevertheless switched by way of the second control device 54. In addition, a detection device could be provided which detects a failure of the first control device or the first valve device 34. In this way, the second control device constitutes the safety means. In this case too, the safety means, here the second control device, can be designed in such a way that it also effects a switching in a manner dependent upon an internal pressure in the containers.

In the case of the embodiment shown in FIG. 6 a detection device 56 is provided which detects an error function of the first valve device 34. If an error function of this type is detected, a further procedure can be initiated (in particular automatically), such as for example an emergency stop of the plant or, on the other hand, a return of the blow moulding nozzle device 42 by a movement of the stretch rod. It would therefore be possible for example for the internal pressure of the bottle or the valve position to be monitored. If the detection device 56 detects that the measured values deviate from the nominal values, a further procedure can be initiated in order to achieve the nominal values. It would also be possible for a pivoting away of the transfer star wheel clamps to be initiated in order to prevent a collision with components of the shaping station, in particular the stressing device. In this case too, a detection device could again be provided which determines an internal pressure in the container in order to take these pressure values too into consideration during the evaluation for example of the question of the performance of an emergency stop.

FIG. 7 shows a further embodiment of the present invention. In this case a further emergency venting is provided, which has the effect that in the event of a failure of the valve 34 the latter or the valve space 35 respectively will be vented and so the stressing device will be moved back. It would also be possible, however, in the event of an emergency venting of this type, for the latter to be provided on a reservoir 38 and, in this way, an emergency venting and thus also an emergency return of the stressing device 42 take place. In this case it is possible, however, for all the stressing devices to be moved back, and this involves at least a certain waste of ready finished containers. This is more acceptable, however, than a collision of the blow moulding nozzle with further elements of the apparatus. Expressed in more precise terms, as shown in FIG. 7, a control space of the valve device can be released.

The reference number 48 refers in a roughly diagrammatic manner to a further safety means, in this case in the form of an aeration device or venting device respectively.

This can be arranged in this case both on the reservoir and (not exhaustively) alternatively at one of the other positions illustrated in the figure, i.e. for example also on the valve 34 or the drive device 35.

In addition, it is also possible for the movement of the stressing device 42 to be coupled to the movement of the stretch rod 8 and in this case a return is carried out in the event of an emergency. In this case, in the event of a failure of the first valve device 34 the stretch rod 8 can carry out the forced release or the return respectively of the stressing device 42. In addition, it would also be possible for the triggering of a safety function to be coupled to the movement of the stretch rod. In the case of a stretch blow moulding procedure the stretch rod is withdrawn out of the container again at a specified point in time. This is preferably carried out by means of an electrical drive. If a control means now establishes that for example the stretch rod cannot be drawn out of the container at a pre-set point in time, for example since a pressure release has not yet taken place, then a return movement of the stressing device can also be initiated in reaction to an observation of this type. In this case for example the safety means can be incorporated in a control means of a drive for carrying out the movement of the stretch rod.

In this case a mechanical safety function can be present, such as for example a coupling during the return, but an initiation of the forcible release without contact would also be possible, for example an observation that the stressing device 42 is not yet withdrawn, although the stretch rod is already present in a specified position.

In this case a return of the stressing device 42 can be carried out, for example by way of a further valve or an additional drive.

FIG. 8 is a diagrammatic illustration of a stressing device 42 applied to a plastics material pre-form. This stressing device is in this case a component part of a blow moulding piston 44 or is arranged on a blow moulding piston respectively. The stretch rod (not shown) is guided inside this blow moulding piston. This stretch rod has arranged on it, however, a cone 8a, which can co-operate with the blow moulding piston 44 in order to withdraw the latter out of the container, in particular after the expansion of the latter has taken place.

The reference number 30 refers to a drive arrangement which is used in this case for moving the stressing device 42 in the direction L. This drive arrangement has in this case a pneumatic drive device 37 or a piston device 37a respectively which can be moved downwards, i.e. towards the plastics material pre-form 10, or upwards, i.e. away from the plastics material pre-form 10, by being acted upon with a gaseous medium. As shown in FIG. 8, the drive arrangement 30 can have a pneumatic cylinder (in particular double-acting).

FIG. 9 is a further diagrammatic illustration to explain the pressure ratios or force ratios respectively. A reservoir 38, such as for example an annular space, is illustrated here. Starting from this annular space, a pressure or a force respectively which may be above 2 kN is exerted upon the blow moulding piston in the direction of the plastics material container 20: A seal with respect to the blow moulding piston 44 can be produced by means of a sealing device 39. A high pressure likewise prevails in the container, in particular towards the end of the expansion procedure. If the pressure is not released from the container 20 a return movement of the stressing device by the drive of the stretch rod is not possible.

The Applicants reserve the right to claim all the features disclosed in the application documents as being essential to the invention, insofar as they are novel either individually or in combination as compared with the prior art.

### LIST OF REFERENCES

1 shaping stations
2 rotatable carrier
8 stretch rod
10 plastics material pre-form
18 stretch rod drive
20 plastics material containers
22 feed device
24 removal device
30 drive arrangement
34 first valve device
35 drive device or valve space respectively
37 drive device
37a piston device
38 reservoir
39 sealing device
40 shaping stations
42 stressing device/blow moulding nozzle
44 blow moulding piston
46 valve block
48 aeration/venting device
52, 54 pilot control devices
56 detection device
112 blow moulding nozzle cam
114 blow moulding slide
L longitudinal direction

1. An apparatus (1) for the shaping of plastics material pre-forms (10) into plastics material, containers (20), with a movable carrier (2) on which are arranged a plurality of shaping stations (40), wherein these shaping stations (40) form in each case cavities in which the plastics material pre-forms (10) are capable of being expanded into the plastics material containers with a flowable medium, and wherein the shaping stations (40) have in each case stressing devices (42) which act upon the plastics material pre-forms (10) with the flowable medium, as well as stretch rods (8) which are capable of being introduced into an internal space of the plastics material pre-forms (10) in order to stretch the aforesaid plastics material pre-forms (10) in the longitudinal direction (L) thereof, and wherein the apparatus has at least one drive arrangement (30) in order to move the stressing devices (42) relative to the plastics material pre-form (10), wherein the drive arrangement (30) has at least one first valve device (34), wherein a change in a switching state of this valve device (34) releases the removal movement of the stressing device (42) and the shaping station (40) has a safety means (36, 54, 56, 46) which even in the event of failure of an element of the first drive arrangement (30) effects the removal of the stressing devices (42) from the plastics material pre-form in a manner dependent upon a pressure prevailing in the container at a pre-determined moment in time, in that a change in the switching state of the valve device (34) is constrained and/or avoided.

2. An apparatus (1) according to claim 1, wherein the movement which removes the stressing device (42) from the plastics material pre-form is carried out without the use of stationary guide elements.

3. An apparatus (1) according to claim 1, wherein, in addition to the first valve device (34), a second valve device (36) is provided which is likewise suitable—as a result of a change in a switching state of this second valve device (36)—for releasing the removal movement of the stressing device (42).

4. An apparatus (1) according to claim 1, wherein the first valve device (34) has two control devices independent of each other at least in part in order to control this valve device (34).

5. An apparatus (1) according to claim 1, wherein a detection device (56) is provided which detects an error function of the first valve device (34).

6. An apparatus (1) according to claim 1, wherein the apparatus (1) has a venting device (46) which in the event of a failure of the first valve device (34) causes a venting of at least one fluid space used for changing the switching state of this valve device.

7. A method of shaping plastics material pre-forms (10) into plastics material containers (20) with the steps:
transferring a plastics material pre-form (10) to a shaping station (40),
bringing a stressing device (42) up to the plastics material pre-form (10),
acting upon an internal space of the plastics material pre-form (10) with a flowable medium for the expansion thereof,
moving the stressing device (42) away from the plastics material container (20) after the expansion of the plastics material pre-form (10) has taken place,
wherein a drive arrangement (30) is used in order to move the stressing device (42) away from the plastics material pre-form (10), and this drive arrangement (30) has at least one first valve device (34),
wherein the removal movement of the stressing device (42) is released by a change in a switching state of this valve device (34),
wherein at least one safety means is provided which in the event of failure of the valve device (34) releases a removal of the stressing device (42) from the plastics material pre-form (10).

8. A method according to claim 7, wherein in the event of a failure of the valve device the safety means causes or avoids a change in the switching state of the valve device.

9. A method according to claim 7, wherein the removal of the stressing device (42) is carried out by a drive device (35) operating in an electrical manner.

10. A method according to claim 7, wherein for the purpose of the shaping procedure a stretch rod is introduced into the plastics material pre-forms (10) in order to stretch them and this stretch rod is moved out of the container again at a later period of time.

11. A method according to claim 9, wherein the removal of the stressing device (42) is carried out by a mechanical coupling of a movement of the stressing device to a movement of the stretch rod (8) at least in the event of a failure of the valve device.
